(19) United States
(12) Patent Application Publication
(10) Pub. No.: US 2015/0242791 A1
(43) Pub. Date: Aug. 27, 2015

(54) SYSTEM AND METHOD TO ANALYZE GAP BETWEEN CUSTOMER EXPERIENCE AND SERVICE PROVIDER EXPERIENCE

(71) Applicant: Tata Consultancy Services Limited, Mumbai (IN)

(72) Inventor: Sachin Ramesh Parandker, Hyderabad (IN)

(21) Appl. No.: 14/630,844

(22) Filed: Feb. 25, 2015

(30) Foreign Application Priority Data
Feb. 25, 2014 (IN) 654/MUM/2014

(51) Int. Cl. G06Q 10/06; G06Q 30/02

(52) U.S. Cl. CPC G06Q 10/06393; G06Q 30/0203

(57) ABSTRACT

The present subject matter discloses system and method for determining gap between customer experience and service provider experience. At first, plurality of experience indicators is defined. Further, customer and service provider experience corresponding to each of the plurality of experience indicators is captured on pre-defined scale. The customer experience is captured by receiving first set of service ratings corresponding to first set of parameters. The service provider experience is captured by receiving second set of service ratings corresponding to second set of parameters. Further, first set of gaps and second set of gaps are determined based on the first set of service ratings and the second set of service ratings. Further, by comparing the first set of gaps and the second set of gaps, the gap between the customer experience and the service provider experience may be determined.

### CROSS-REFERENCE TO RELATED APPLICATIONS AND PRIORITY

The present application claims priority to Indian Provisional Patent Application No. 654/MUM/2014, filed on Feb. 25, 2014, the entirety of which is hereby incorporated by reference.

### TECHNICAL FIELD

The present disclosure in general relates to system and method to analyze gap between a customer experience and a service provider experience.

### BACKGROUND

A Customer Experience (CE) Framework is a business framework which measures and analyzes a customer perception towards a service provided by a service provider. The analysis of the customer perception helps in changing or improving internal business strategies to improve customer satisfaction and experience. Generally, the service provider presents a specification as standard operating procedures to the customers for receiving their perceptions for the service. On the contrary, the customers have their own specifications based on their need-driven expectations for changes to their process-inputs. Misalignment between the service provider specification and the customer-specification for the service process leads to dissatisfaction, even when the process goes exactly as it was designed. Thus, it is challenge for the service provider to understand and address individual customer needs.

For understanding the customer needs, the service provider captures customer's view or perceptions, for the service provided, from different sources. However, due to qualitative nature of the perception, it is practically difficult to understand and have a standard unit of scale for measuring the perceptions received from different customers. The perceptions received changes over time and situation. For example, two people may perceive same things differently and also the same person may perceive same thing differently at different times. Thus, there exist gaps between what the customer expects and what the service provider delivers.

### SUMMARY

This summary is provided to introduce aspects related to systems and methods for determining a gap between customer experience and service provider experience for a service and the concepts are further described below in the detailed description. This summary is not intended to identify essential features of subject matter nor is it intended for use in determining or limiting the scope of the subject matter.

In one implementation, a system for determining a gap between customer experience and service provider experience for a service is disclosed. The system comprises a processor and a memory coupled to the processor. The processor executes a plurality of modules stored in the memory. The plurality of modules comprises a defining module, a capturing module, and a determining module. The defining module may define a plurality of experience indicators corresponding to a customer and a service provider. Further, the capturing module may capture a customer experience, in customer's perspective, and a service provider experience, in service provider's perspective, corresponding to each of the plurality of experience indicators on a pre-defined scale. The customer experience may be captured by receiving a first set of service ratings from the customer corresponding to a first set of parameters. The service provider experience may be captured by receiving a second set of service ratings from the service provider corresponding to a second set of parameters. The first set of service ratings and the second set of service ratings may be received on a pre-defined scale. Further, the determining module may determine a first set of gaps and a second set of gaps corresponding to the customer experience and the service provider experience respectively. The first set of gaps may be determined based on the first set of service ratings received corresponding to the first set of parameters. The second set of gaps may be determined based on the second set of service ratings received corresponding to the second set of parameters. The determining module may further determine the gap between the customer experience and the service provider experience by comparing the first set of gaps and the second set of gaps.

In another implementation, a method for determining a gap between customer experience and service provider experience for a service is disclosed. The method may comprise defining, by a processor, a plurality of experience indicators corresponding to a customer and a service provider. The method may further comprise capturing, by the processor, a customer experience, in customer's perspective, and a service provider experience, in service provider's perspective, corresponding to each of the plurality of experience indicators on a pre-defined scale. The customer experience may be captured by receiving a first set of service ratings from the customer corresponding to a first set of parameters. The service provider experience may be captured by receiving a second set of service ratings from the service provider corresponding to a second set of parameters. The first set of service ratings and the second set of service ratings may be received on a pre-defined scale. The method may further comprise a step of determining, by the processor, a first set of gaps and a second set of gaps corresponding to the customer experience and the service provider experience respectively. The first set of gaps may be determined based on the first set of service ratings received corresponding to the first set of parameters. The second set of gaps may be determined based on the second set of service ratings received corresponding to the second set of parameters. Further, the method may comprise the step of determining, by the processor, the gap between the customer experience and the service provider experience by comparing the first set of gaps and the second set of gaps.

In yet another implementation a non-transitory computer readable medium embodying a program executable in a computing device for determining a gap between customer experience and service provider experience for a service. The program may comprise a program code for defining a plurality of experience indicators corresponding to a customer and a service provider. The program may further comprise a program code for capturing a customer experience, in customer's perspective, and a service provider experience, in service provider's perspective, corresponding to each of the plurality of experience indicators on a pre-defined scale. The customer experience may be captured by receiving a first set of service ratings from the customer corresponding to a first set of parameters. The service provider experience may be captured by receiving a second set of service ratings from the service provider corresponding to a second set of parameters. The first set of service ratings and the second set of service ratings may be received on a pre-defined scale. Further, the program may further comprise a program code for determining a first set of gaps and a second set of gaps corresponding to the customer experience and the service provider experience respectively. The first set of gaps may be determined based on the first set of service ratings received corresponding to the first set of parameters. The second set of gaps may be determined based on the second set of service ratings received corresponding to the second set of parameters. The program may further comprise a program code for determining the gap between the customer experience and the service provider experience by comparing the first set of gaps and the second set of gaps.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for determining a gap between a customer experience and a service provider experience for a service, in accordance with an embodiment of the present disclosure.

FIG. 2 illustrates the system, in accordance with an embodiment of the present disclosure.

FIG. 3 illustrates a customer mind map used to capture the customer experience and the service provider experience on a pre-defined scale, in accordance with an exemplary embodiment of the present disclosure.

FIG. 4 illustrates a method for determining a gap between customer experience and service provider experience for a service, in accordance with an embodiment of the present disclosure.

### DETAILED DESCRIPTION

Systems and methods for determining a gap between customer experience and service provider experience for a service are disclosed. The present disclosure helps in analyzing difference or gaps in understanding customer requirements between what the customer expects and what the service provider delivers. This analysis (gap analysis) may help the service provider to improve over the services catered the customers. In order to perform such gap analysis, a first step is to capture customer experience for the service. The customer experience may include the customer perception or expectations before experiencing the service and after experiencing the service. But, due to the qualitative nature of the perception, it becomes a challenge for the service providers to exactly understand them. Over the time and situation, it has been observed that perceptions of same set of people may differ. Thus, the first and foremost requirement is to define a standard unit of scale (customer experience scale) for measuring the perceptions received from the customers. The scale defined may provide a common measuring scale on which the system may rely for receiving and measuring the perceptions received from the customers. Thus, the system considers the factor of subjective introspection for performing the gap analysis.

Not only the customer experience, the system may also capture the service provider experience for the service. Hence, the system captures the experiences from both the perspectives i.e., customer's perspective and service provider's perspective. For capturing the experiences (customer experience and service provider experience), a plurality of customer experience indicators (experience indicators) may be defined by the system. Further, the system may capture the customer experience and the service provider experience corresponding to each of the plurality of experience indicators based on a pre-defined scale. Further, the experiences may be captured by receiving service ratings from the customers and the service providers based on the pre-defined scale. Further, the customer experience and the service provider experience captured for each of the plurality of experience indicators may be used to identify and analyze the gaps between the customer experience and the service provider experience for the service.

While aspects of described system and method for determining the gap between the customer experience and the service provider experience for the service may be implemented in any number of different computing devices, environments, and/or configurations, the embodiments are described in the context of the following exemplary systems.

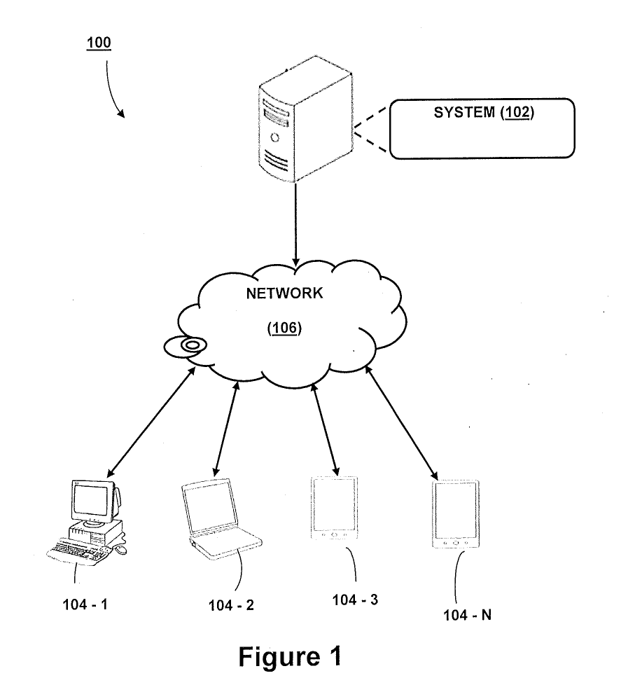

Referring to FIG. 1, a network implementation 100 of system 102 for determining the gap is illustrated, in accordance with an embodiment of the present subject matter. In one embodiment, the system 102 facilitates the determining of the gap between the customer experience and the service provider experience for the service. Although the present disclosure is explained considering that the system 102 is implemented as a software application on a server, it may be understood that the system 102 may also be implemented in a variety of computing systems, such as a laptop computer, a desktop computer, a notebook, a workstation, a mainframe computer, a network server, a tablet, a mobile phone, and the like. In one implementation, the system 102 may be implemented in a cloud-based environment. It will be understood that the system 102 may be accessed by multiple users through one or more user devices 104-1, 104-2 . . . 104-N, collectively referred to as user 104 hereinafter, or applications residing on the user devices 104. Examples of the user devices 104 may include, but are not limited to, a portable computer, a personal digital assistant, a handheld device, and a workstation. The user devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the Internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

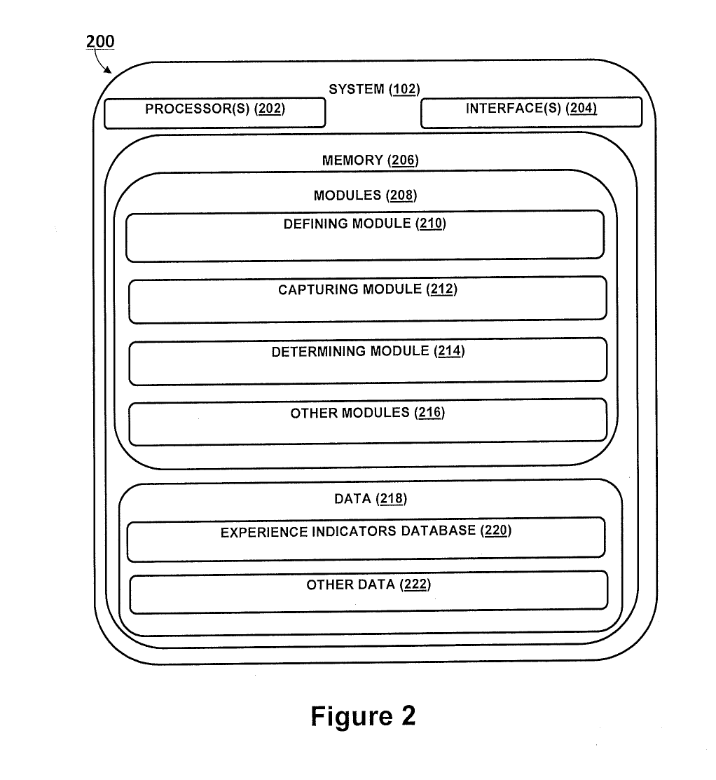

Referring now to FIG. 2, the system 102 is illustrated in accordance with an embodiment of the present subject matter. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions or modules stored in the memory 206.

The I/O interface 204 may include a variety of software and hardware interfaces, for example, a web interface, a graphical user interface, and the like. The I/O interface 204 may allow the system 102 to interact with a user directly or through the client devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium or computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, a compact disks (CDs), digital versatile disc or digital video disc (DVDs) and magnetic tapes. The memory 206 may include modules 208 and data 218.

The modules 208 include routines, programs, objects, components, data structures, etc., which perform particular tasks or implement particular abstract data types. In one implementation, the modules 208 may include a defining module 210, a capturing module 212, a determining module 214, and other modules 216. The other modules 216 may include programs or coded instructions that supplement applications and functions of the system 102.

The data 218, amongst other things, serves as a repository for storing data processed, received, and generated by one or more of the modules 208. The data 218 may also include, experience indicators database 220 and other data 222.

According to embodiments of present disclosure, an example is illustrated for determining the gaps between the customer experience and service provider experience for a service. At first, the defining module 210 of the system 102 may define a plurality of experience indicators corresponding to the customer and the service provider. The experience indicators may comprise, but are not limited to, a support capability experience, a process knowledge experience, a client willingness experience, a quick response experience, an assistance to contact experience, and a consistency experience. Further, the plurality of experience indicators may be stored in the experience indicators database 220 of the system 102.

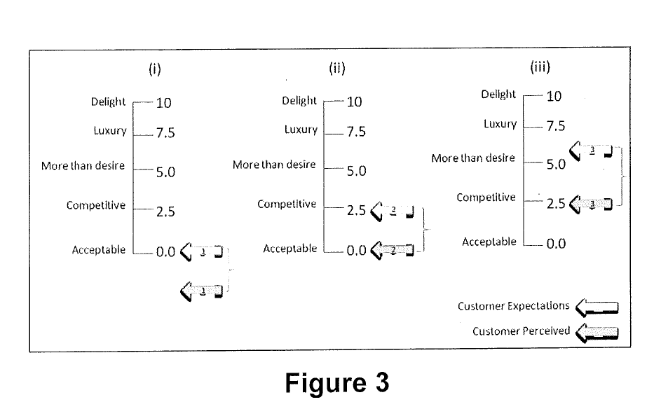

Further, the capturing module 212 of the system 102 may capture the customer experience in customer's perspective, and a service provider experience in service provider's perspective, corresponding to each of the plurality of experience indicators on a pre-defined scale. The pre-defined scale is explained by referring a customer mind map as shown in FIG. 3.

The FIG. 3 illustrates how a mind of the customer may be perceived for capturing the customer experience. In an embodiment, a plurality of experience levels (acceptable, competitive, more than desire, luxury, and delight) of the pre-defined scale may be seen from the customer mind map of the FIG. 3. The pre-defined scale may be validated and updated as per the observations and findings of a research. According to embodiments of present disclosure, the customer mind map may be defined assuming that the pre-defined scale is same in the mind of the customer and the service provider.

Further, the pre-defined scale may comprise a plurality of service ratings such as 0.0, 2.5, 5.0, 7.5 and 10. Each of the service rating may be associated with an experience level of the plurality of experience levels. For example, the service rating “0.0” (acceptable) indicates that the customer may perceive the service as acceptable to use for the customer's need. Similarly, the service rating “2.5” (competitive) indicates that the customer may look for options and exercise his choice. Similarly, the service rating “5.0” (more than desire) indicates that the customer's satisfaction level i.e., the customer is satisfied with the service provided. Further, the service rating “7.5” (luxury) indicates that the service may be considered as a preferred service but dissatisfaction of the customer may not be ruled out. Further, the service rating “10” (delight) indicates that the customer may feel delighted and may look for a long term relationship with the service provider. According to some embodiments of present disclosure, the customer and service provider may provide a service rating of any numerical value between ranges provided on the pre-defined scale.

The customer mind map shown in the FIG. 3 illustrates three iterations of the service availed by the customer and changes in the customer perception and customer expectation with each service iteration. For each of the iterations of the service, the customer expectations may be seen increasing exponentially. The change in the customer expectation may vary from one customer to another customer based on a plurality of factors. The plurality of factors may comprise but are not limited to culture, geography, service, and nature of the customer.

By way of a non-limiting example, when the customer has a positive perception, the customer expectation may be above perceived levels of the service. In case the customer has a negative perception, the customer expectation may be below perceived levels of the service. Further, a service rating of the plurality of service ratings may reduce with time because the customer expectation may increase with time. For example, the service rating of 7.5 ‘luxury’ may become an acceptable limit over time. The service may continue to hold the customer as long as it scores more than 5 on the pre-defined customer experience scale.

Further, the capturing of the customer experience and the service provider experience by the capturing module 212 may be explained by referring to Table 1 below.

TABLE 1

| | Customer End | | Service Provider End | |
|---|---|---|---|---|
| | Perception | Service | Perception | Service |
| Step | 1 | Rating 1 | 2 | Rating 2 |
| 1 | Quality of Experience | 10 | | |
| | Expected | | | |
| 2 | Quality of Experience | 8 | | |
| | Expected expressed to | | | |
| | the Service Provider | | | |
| 3 | | | Quality of Experience | 7 |
| | | | Expected understood | |
| | | | by the Service Provider | |
| 4 | | | Quality of Service | 6 |
| | | | provided for Expected | |
| | | | Quality Experience | |
| 5 | Quality Experienced | 5 | | |
| | out of quality of the | | | |
| | service provided | | | |
| 6 | Quality Experience | 4 | | |
| | expressed by the | | | |
| | customer to the | | | |
| | service provider as | | | |
| | a feedback (CSI) | | | |
| 7 | | | Feedback (CSI) | 4.5 |
| | | | understood by the | |
| | | | service provider. The | |
| | | | gaps in understanding | |
| | | | occur because the | |
| | | | satisfaction scale of | |
| | | | 0-9 is again | |
| | | | understood relative | |
| | | | to the service | |
| | | | provider. | |

According to embodiments, the customer experience may be captured by receiving a first set of service ratings from the customer corresponding to a first set of parameters. Referring to the above table 1, the first set of service ratings indicates “service rating 1” displayed under column titled “customer end”. Further, the first set of parameters indicates parameters listed under sub-column, titled “perception 1”, of the column “customer end”. Further, the first set of service ratings may be received on the pre-defined scale. For example, a service rating received by the customer for a parameter “Quality of Experience Expected expressed to the Service Provider” is “8”. Similarly, a service rating received by the customer for a parameter “Quality Experience expressed by the customer to the service provider as a feedback (CSI)” is “4”. Further, a service rating received by the customer for the parameter “Quality of Experience Expected” is “10”.

According to the embodiments of present disclosure, the service provider experience may be captured by receiving a second set of service ratings from the service provider corresponding to a second set of parameters. Referring to the above table 1, the second set of service ratings indicate “service rating 2” displayed under column titled “service provider end”. Further, the second set of parameters indicates parameters listed under sub-column, titled “perception 2”, of the column “service provider end”. Further, the second set of service ratings may be received on the pre-defined scale. For example, a service rating received by the service provider for a parameter “Quality of Experience Expected understood by the Service Provider” is “7”. Similarly, a service rating received by the service provider for a parameter “Quality of Service provided for Expected Quality Experience” is “6”. Further, a service rating received by the service provider for the parameter “Feedback (CSI) understood by the service provider.” is “4.5”.

After capturing the first and the second service ratings, the determining module 214 of the system 102 may determine a first set of gaps and a second set of gaps corresponding to the customer experience and the service provider experience respectively. According to embodiments of present disclosure, the first set of gaps determined is shown below in table 2.

TABLE 2

| Gap Description | Steps Involved | First Set of Gaps |
|---|---|---|
| Gap in understanding | Step 2-Step 6 | 8 − 4 = 4 |
| customer feedback (CSI) as | | |
| per the customer = | | |
| Gap in customer delight as | Step 1-Step 6 | 10 − 4 = 6 |
| per the customer = | | |

Similarly, the second set of gaps determined is shown in below table 3.

TABLE 3

| Gap Description | Steps Involved | Second Set of Gaps |
|---|---|---|
| Gap in understanding | Step 4-Step 7 | 6 − 4.5 = 1.5 |
| customer feedback (CSI) as | | |
| per the service provider = | | |
| Gap in customer delight as | Step 3-Step 7 | 7 − 4.5 = 2.5 |
| per the service provider = | | |

Further, the determining module 214 (based on the table 2 and table 3), may determine the gap between the customer experience and the service provider experience by comparing the first set of gaps and the second set of gaps. For example, the gap between the customer experience (in understanding customer feedback (CSI) as per the customer) and the service provider experience (in understanding customer feedback (CSI) as per the service provider) is determined as 4 minus 1.5 which is equal to 2.5. In other example, the gap between the customer experience (in customer delight as per the customer) and the service provider experience (in customer delight as per the service provider) is determined as 6 minus 2.5 which is equal to 3.5.

Further, the determining module 214 may also determine a satisfaction level of the customer based on the above gap analysis. If a gap of the second set of gaps is greater than a gap of the first set of gaps, then the customer is not satisfied by the service provided by the service provider. On the contrary, if the gap of the second set of gaps is lesser than the gap of the first set of gaps, then the customer is satisfied by the service provided by the service provider. In other words, the gap may be further analyzed to show that the gap understood by the service provider is less than the gap understood by the customer. Hence, the service provider with lesser gap may not retain the customer or may not have satisfied or delighted customers.

In another embodiment of present disclosure, the capturing of customer experience and the service provider experience by the capturing module 212 may be explained by referring to Table 4 below. According to this embodiment, the customer and the service provider experience may be captured corresponding to the experience indicator i.e., “support capability experience”.

TABLE 4

| | Customer End | | Service Provider End | |
|---|---|---|---|---|
| | Perception | Service | Perception | Service |
| Step | 1 | Rating 1 | 2 | Rating 2 |
| 1 | Quality of support | 10 | | |
| | capability Expected | | | |
| 2 | Quality of support | 8.5 | | |
| | capability Expected | | | |
| | expressed to the | | | |
| | Service Provider | | | |
| 3 | | | Quality of support | 7.5 |
| | | | capability Expected | |
| | | | understood by the | |
| | | | Service Provider | |
| 4 | | | Quality of Service | 6.5 |
| | | | provided for Expected | |
| | | | Quality of support | |
| | | | capability | |
| 5 | Quality of support | 5.5 | | |
| | capability out of | | | |
| | quality of service | | | |
| | provided | | | |
| 6 | Quality of support | 4.25 | | |
| | capability expressed | | | |
| | by the customer to | | | |
| | the provider as a | | | |
| | feedback (CSI) | | | |
| 7 | | | Feedback (CSI) | 4.5 |
| | | | understood by provider. | |
| | | | The gap in understanding | |
| | | | occurs because the | |
| | | | satisfaction scale of 0-10 | |
| | | | is again understood | |
| | | | relative to provider's | |
| | | | perception | |

Further, the customer experience captured by receiving the first set of service ratings corresponding to the first set of parameters can be clearly seen from the above table 4. For example, a service rating received by the customer for a parameter “Quality of support capability Expected expressed to the Service Provider” is 8.5. Similarly, the service ratings received by the customer for other parameter i.e., “Quality of support capability Expected” and “Quality of support capability expressed by the customer to the provider as a feedback (CSI)” is “10” and “4.25” respectively.

Similar to this, the second set of service ratings received for the second set of parameters may also be seen from the above table 4. For example, a service rating received for the parameter “Quality of support capability Expected understood by the Service Provider” is “7.5”. Similarly, the service ratings received for the parameters “Quality of Service provided for Expected Quality of support capability” and “Feedback (CSI) understood by provider” is “6.5” and “4.5” respectively.

Further, the determining module 214 may determine the first set of gaps and the second set of gaps corresponding to the customer experience and the service provider experience respectively. According to embodiments of present disclosure, the first set of gaps determined is shown below in table 5.

TABLE 5

| Gap Descriptions | Steps Involved | First Set of Gaps |
|---|---|---|
| Gap in understanding | Step 2-Step 6 = | 8.5 − 4.25 = 4.25 |
| customer feedback (CSI) as | | |
| per the customer | | |
| Gap in the customer delight | Step 1-Step 6 = | 10 − 4.25 = 5.75 |
| as per the customer | | |

Similarly, the second set of gaps determined is shown in below table 6.

TABLE 6

| Gap Descriptions | Steps Involved | Second Set of Gaps |
|---|---|---|
| Gap in understanding | Step 4-Step 7 = | 6.5 − 4.5 = 2 |
| customer feedback (CSI) as | | |
| per the service provider | | |
| Gap in the customer delight | Step 3-Step 7 = | 7.5 − 4.5 = 3 |
| as per the service provider | | |

Further, the determining module 214 (based on above table 5 and table 6), may determine the gap between the customer experience and the service provider experience for the experience indicator (support capability experience) by comparing the first set of gaps and the second set of gaps. For example, the gap between the customer experience (in understanding customer feedback (CSI) as per the customer) and the service provider experience (in understanding customer feedback (CSI) as per the service provider) is determined as 4.25 minus 2 which is equal to 2.25. In other example, the gap between the customer experience (in customer delight as per the customer) and the service provider experience (in customer delight as per the service provider) is determined as 5.75 minus 3 which is equal to 2.75.

Based on the above gap analysis, the determining module 214 may further determine the satisfaction level of the customers. The gaps (between the customer and service provider experience) may be further analyzed by the determining module 214 to show that the gap understood by the service provider is less than the gap understood by the customer. Hence, the service provider with lesser gap may not retain the customer or may not have satisfied or delighted customers.

Similarly, the gaps may be determined between the customer experience and the service provider experience for each of the plurality of experience indicators i.e., process knowledge experience, client willingness experience, quick response experience, assistance to contact experience, and consistency experience.

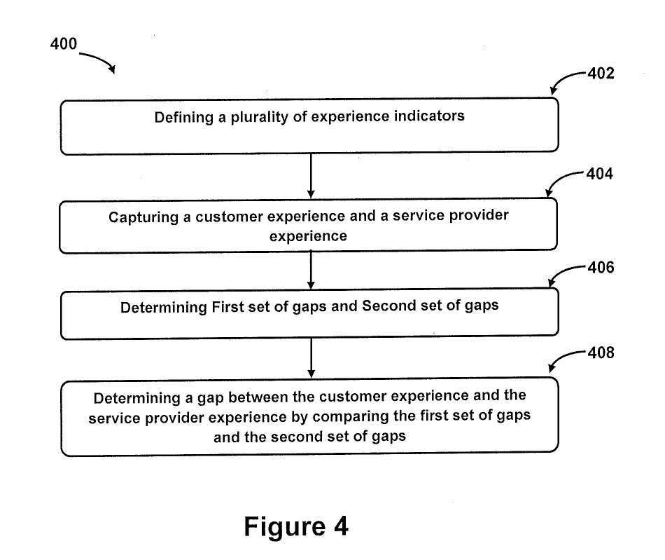

Referring now to FIG. 4, a method for determining the gap between customer experience and service provider experience for a service is shown, in accordance with an embodiment of the present subject matter. The method 400 may be described in the general context of computer executable instructions. Generally, computer executable instructions can include routines, programs, objects, components, data structures, procedures, modules, functions, etc., that perform particular functions or implement particular abstract data types. The method 400 may also be practiced in a distributed computing environment where functions are performed by remote processing devices that are linked through a communications network. In a distributed computing environment, computer executable instructions may be located in both local and remote computer storage media, including memory storage devices.

The order in which the method 400 is described is not intended to be construed as a limitation, and any number of the described method blocks can be combined in any order to implement the method 400 or alternate methods. Additionally, individual blocks may be deleted from the method 400 without departing from the spirit and scope of the subject matter described herein. Furthermore, the method 400 can be implemented in any suitable hardware, software, firmware, or combination thereof. However, for ease of explanation, in the embodiments described below, the method 400 may be considered to be implemented in the above described system 102.

At block 402, a plurality of experience indicators corresponding to a customer and a service provider may be defined. Further, the plurality of experience indicators may comprise, but not limited to, a support capability experience, a process knowledge experience, a client willingness experience, a quick response experience, an assistance to contact experience, and a consistency experience.

At block 404, a customer experience, in customer's perspective, and a service provider experience, in service provider's perspective, may be captured corresponding to each of the plurality of experience indicators on a pre-defined scale. Further, the customer experience may be captured by receiving a first set of service ratings from the customer corresponding to a first set of parameters. Further, the service provider experience may be captured by receiving a second set of service ratings from the service provider corresponding to a second set of parameters.

At block 406, the first set of gaps and a second set of gaps corresponding to the customer experience and the service provider experience respectively may be determined. The first set of gap may be determined based on the first set of service ratings received corresponding to the first set of parameters. Further, the second set of gap is determined based on the second set of service ratings received corresponding to the second set of parameters.

At block 408, the gap between the customer experience and the service provider experience may be determined by comparing the first set of gaps and the second set of gaps.

Although implementations for system and method for determining the gaps have been described in language specific to structural features and/or methods, it is to be understood that the description are not necessarily limited to the specific features or methods described. Rather, the specific features and methods are disclosed as examples of implementations for determining the gaps between the customer experience and the service provider experience.

We claim:

1. A method for determining a gap between customer experience and service provider experience for a service, the method comprising:
defining, by a processor, a plurality of experience indicators corresponding to a customer and a service provider;
capturing, by the processor, a customer experience, in customer's perspective, and a service provider experience, in service provider's perspective, corresponding to each of the plurality of experience indicators on a pre-defined scale, wherein
the customer experience is captured by receiving a first set of service ratings from the customer corresponding to a first set of parameters, and
the service provider experience is captured by receiving a second set of service ratings from the service provider corresponding to a second set of parameters and wherein the first and the second set of service ratings are received on the pre-defined scale;
determining, by the processor,
a first set of gaps and a second set of gaps corresponding to the customer experience and the service provider experience respectively, wherein the first set of gaps is determined based on the first set of service ratings received corresponding to the first set of parameters, and wherein the second set of gaps is determined based on the second set of service ratings received corresponding to the second set of parameters, and
a gap between the customer experience and the service provider experience by comparing the first set of gaps and the second set of gaps.

2. The method of claim 1, further comprising determining satisfaction level of the customer for the service based on the first set of gaps and the second set of gaps, wherein if a gap of the second set of gaps is greater than a gap of the first set of gaps, then the customer is not satisfied by the service provided by the service provider.

3. The method of claim 1, wherein the plurality of experience indicators comprises support capability experience, process knowledge experience, client willingness experience, quick response experience, assistance to contact experience, and consistency experience

4. The method of claim 1, wherein the first and the second set of service ratings indicates a numerical value on the pre-defined scale, and wherein the pre-defined scale comprises a plurality of experience levels.

5. A system 102 for determining a gap between customer experience and service provider experience for a service, the system 102 comprises:
a processor 202;
a memory 204 coupled with the processor 202, wherein the processor 202 executes plurality of modules 208 stored in the memory 204, wherein the plurality of modules comprising:
a defining module 210 to define a plurality of experience indicators corresponding to a customer and a service provider;
a capturing module 212 to capture a customer experience, in customer's perspective, and a service provider experience, in service provider's perspective, corresponding to each of the plurality of experience indicators on a pre-defined scale, wherein
the customer experience is captured by receiving a first set of service ratings from the customer corresponding to a first set of parameters, and
the service provider experience is captured by receiving a second set of service ratings from the service provider corresponding to a second set of parameters, and wherein the first and the second set of service ratings are received on the pre-defined scale;
a determining module 214 to determine a first set of gaps and a second set of gaps corresponding to the customer experience and the service provider experience respectively, wherein the first set of gaps is determined based on the first set of service ratings received corresponding to the first set of parameters, and wherein the second set of gaps is determined based on the second set of service ratings received corresponding to the second set of parameters, and
a gap between the customer experience and the service provider experience by comparing the first set of gaps and the second set of gaps.

6. The system 102 of claim 5, wherein determining module 214 further determines satisfaction level of the customer for the service based on the first set of gaps and the second set of gaps, wherein if a gap of the second set of gaps is greater than a gap of the first gaps, then the customer is not satisfied by the service provided by the service provider.

7. The system 102 of claim 5, wherein the plurality of experience indicators comprises support capability experience, process knowledge experience, client willingness experience, quick response experience, assistance to contact experience, and consistency experience.

8. The system 102 of claim 5, wherein the first and the second set of service ratings indicates a numerical value on the pre-defined scale, and wherein the pre-defined scale comprises a plurality of experience levels.

9. A non-transitory computer readable medium embodying a program executable in a computing device for determining a gap between customer experience and service provider experience for a service, the program comprising:
a program code defining a plurality of experience indicators corresponding to a customer and a service provider;
a program code for capturing a customer experience, in customer's perspective, and a service provider experience, in service provider's perspective, corresponding to each of the plurality of experience indicators on a pre-defined scale, wherein
the customer experience is captured by receiving a first set of service ratings from the customer corresponding to a first set of parameters, and
the service provider experience is captured by receiving a second set of service ratings from the service provider corresponding to a second set of parameters, and wherein the first and the second set of service ratings are received on the pre-defined scale;
a program code for determining
a first set of gaps and a second set of gaps corresponding to the customer experience and the service provider experience respectively, wherein the first set of gaps is determined based on the first set of service ratings received corresponding to the first set of parameters, and wherein the second set of gaps is determined based on the second set of service ratings received corresponding to the second set of parameters, and
a gap between the customer experience and the service provider experience by comparing the first set of gaps and the second set of gaps.
